(19) United States
(12) Patent Application Publication
(10) Pub. No.: US 2026/0140630 A1
(43) Pub. Date: May 21, 2026

(54) ENHANCED DATA STORAGE PROCESSING USING AN AUGMENTED DATA CONTROLLER AND AUGMENTED INSTRUCTIONS

(71) Applicant: NVIDIA Corporation, Santa Clara, CA (US)

(72) Inventors: Christopher J. Newburn, South Beloit, IL (US); Benjamin L. Walker, Chandler, AZ (US); Isaac Gelado Fernandez, Pacifica, CA (US); Vikram Sharma Mailthody, Urbana, IL (US); Kiran Kumar Modukuri, San Ramon, CA (US); Wen-Mei W. Hwu, Champaign, IL (US); Zaid Qureshi, Wappingers Falls, NY (US)

(21) Appl. No.: 19/392,901

(22) Filed: Nov. 18, 2025

Related U.S. Application Data
(60) Provisional application No. 63/721,935, filed on Nov. 18, 2024.

(51) Int. Cl. G06F 3/06

(52) U.S. Cl. CPC G06F 3/0611; G06F 3/0619; G06F 3/0659; G06F 3/0673

(57) ABSTRACT

The disclosure provides an apparatus, system, and method that augments the typical processing by a storage controller for obtaining data. An augmented data controller is disclosed that provides augmented instructions to a storage controller to improve the processing of data requests, such as fine-grained data requests. The augmented data controller provides improved features for processing data requests, such as a request format that groups a set of commands from a requesting agent to the storage controller, and/or groups a set of responses from the storage controller for the requesting agent to process. Semantic guidance for data storage is provided and interaction with the storage controller is extended to support a hierarchical protocol that aggregates across multiple requests. With the augmented storage controller, additional information can be tracked, such as a set of memory regions and sets of data requests.

### CROSS REFERENCE TO RELATED APPLICATION

This application claims the benefit of U.S. Provisional Application Ser. No. 63/721,935, filed by Christopher J. Newburn, et al., on Nov. 18, 2024, entitled “AN AUGMENTED DATA CONTROLLER, A STORAGE PROCESSING INTERFACE INCLUDING THE AUGMENTED DATA CONTROLLER, AND A METHOD OF PROCESSING DATA REQUESTS AND RESPONSES,” which is commonly assigned with this application and incorporated herein by reference in its entirety. This application is also related to U.S. Patent Applications having Docket Nos. 24-MA-1415 US02 and 24-MA-1415 US04, filed by Christopher J. Newburn, et al., on the same day as the present application.

### TECHNICAL FIELD

This application is directed, in general, to data storage, and more specifically, to improving accessing data from data storage, such as improving input/output operations per second (IOPs) when accessing the data.

### BACKGROUND

A new class of applications executing on processors, such as a graphic processing unit (GPU) or a central processing unit (CPU), are making fine-grained accesses, such as from each GPU thread, creating the need for new interfaces, a new infrastructure, and a new generation of storage devices and systems. The amount of data requested is typically greater than local memory and therefore is often stored on external memory devices connected to the processors. The IOPs rates demanded by these new applications, however, cannot be efficiently satisfied by today's solid state drives (SSDs) and/or non-volatile memory express solid state drive (NVMes) and their associated operating system (OS) software stack. Furthermore, although GPUs are better at tolerating latency than CPUs, hierarchical synchronization among threads (e.g. within a warp) and the sheer volume of compute threads that serve as a divisor to the number of requests between synchronization points make tolerating maximal tail latency difficult. Improvements to the processing of data requests and responses can be beneficial to maintaining maximal effective IOPs rates reducing tail latency.

### SUMMARY

In one aspect, the disclosure provides an augmented data controller configured to perform one or more operations associated with obtaining data from data storage for one or more requesting agents. In one example, the operations include providing augmented instructions to a storage controller associated with the data storage, wherein the augmented instructions coordinate data requests from the one or more requesting agents to the storage controller and data responses from the storage controller to the one or more requesting agents and include directions for the storage controller to track at least one set of the data requests.

In another aspect, the disclosure provides a storage processing interface. In one example the storage processing interface includes: (1) a communication bus and (2) an augmented data controller connected to the communication bus and configured to perform one or more operations associated with obtaining data from data storage for one or more requesting agents coupled to the communication bus, the operations including providing augmented instructions to a storage controller associated with the data storage, wherein the augmented instructions coordinate data requests from the one or more requesting agents to the storage controller and data responses from the storage controller to the one or more requesting agents, and include directions for the storage controller to track at least one set of the data requests.

In yet another aspect, the disclosure provides a method of obtaining data from data storage for one or more data requests from one or more requesting agents. In one example the method includes: (1) receiving one or more data requests and semantic information associated with the one or more data requests, wherein at least a portion of the semantic information is generated by and is received from the one or more requesting agents, (2) generating augmented instructions based on the semantic information, wherein the augmented instructions coordinate data requests from the one or more requesting agents to a storage controller and data responses from the storage controller to the one or more requesting agents, wherein the storage controller is associated with the data storage and the augmented instructions include directions for the storage controller to track at least one set of the data requests, and (3) obtaining data for the data requests from the data storage according to the augmented instructions.

### BRIEF DESCRIPTION

Reference is now made to the following descriptions taken in conjunction with the accompanying drawings, in which:

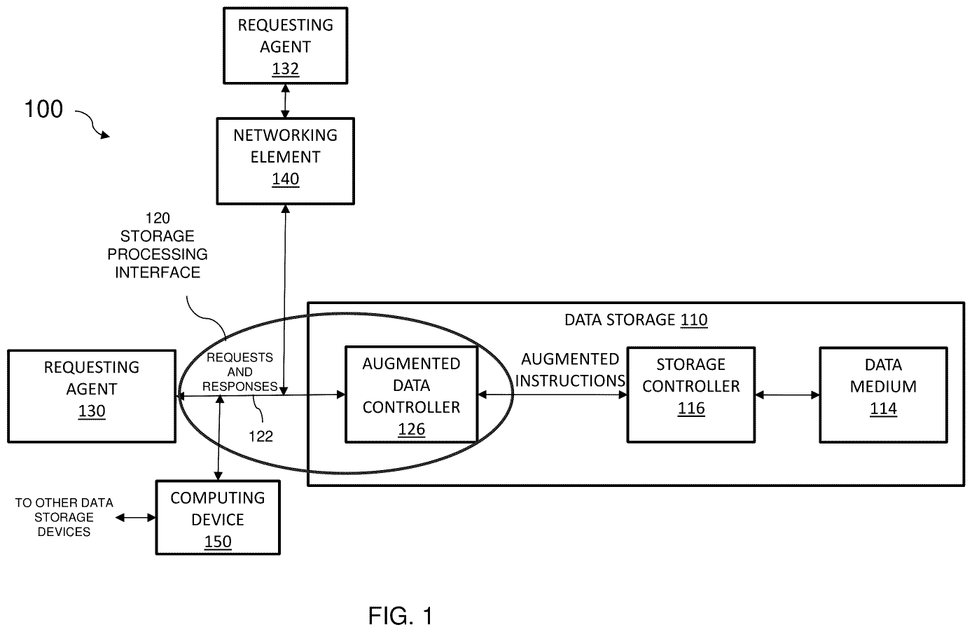

FIG. 1 illustrates a block diagram of an example of a data storage system having a storage processing interface constructed according to the principles of the disclosure;

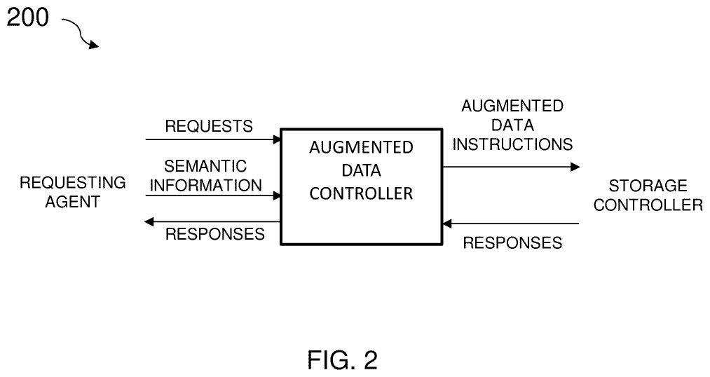

FIG. 2 illustrates a block diagram of an example of an augmented data controller constructed according to the principles of the disclosure;

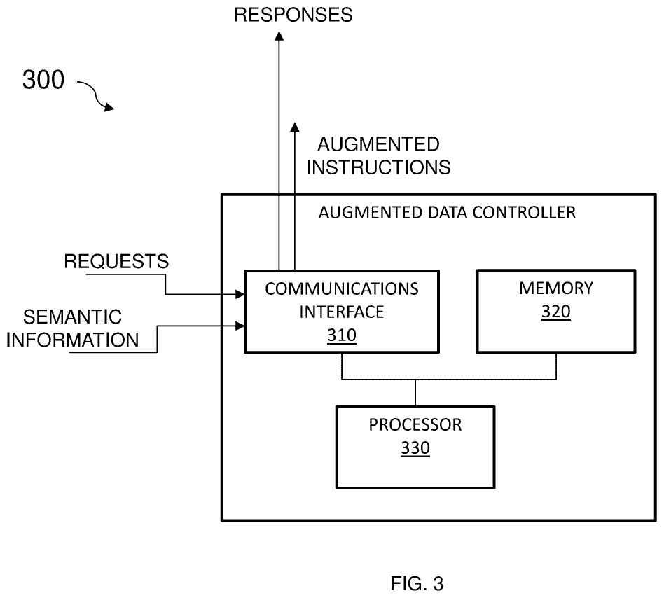

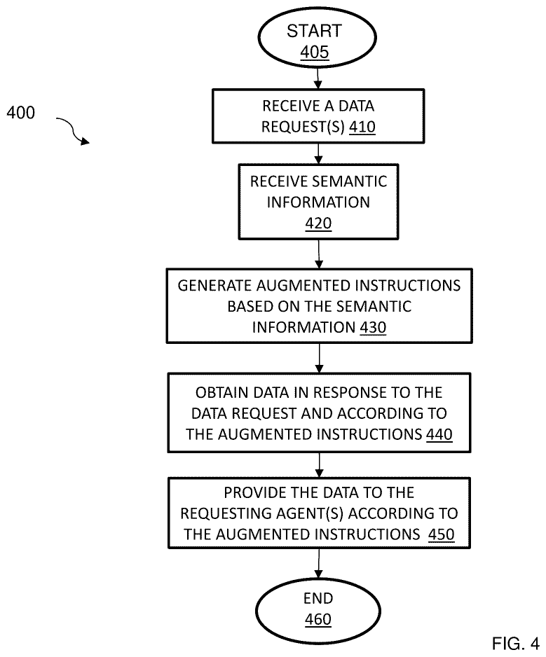

FIG. 3 illustrates a block diagram of another example of an augmented data controller constructed according to the principles of the disclosure; and
FIG. 4 illustrates a flow diagram of an example method of obtaining data from data storage for one or more data requests carried out according to the principles of the disclosure.

### DETAILED DESCRIPTION

Storage controllers for various data storage devices typically receive data requests from requesting agents, such as processors, and interact with a data medium of the data storage device to fulfill the requests and provide a response to the requesting agents. Traditional storage controllers, however, are typically configured to process coarse-grained data accesses and are unable to process fine-grained data request, e.g. 4 KB or less, that are emerging from processors, such as from GPU threads.

Accordingly, the disclosure provides an apparatus, system, and method that augments the typical processing by a storage controller. An augmented data controller is disclosed that provides augmented instructions to a storage controller to improve the processing of data requests, such as fine-grained data requests. The augmented data controller or logic thereof can be located within a storage controller itself or in another device such as a requesting agent, a networking device, or within a data storage device besides within the storage controller. The logic can also be distributed over multiple devices, such as those just mentioned. The logic of the augmented data controller can be implemented as software, hardware, or a combination thereof. The logic can correspond to one or more algorithms that are directed to perform the various features/functions disclosed herein, such as improving data request processing by using augmented instructions.

The augmented data controller provides improved features for processing data requests, such as a request format that groups a set of commands from a requesting agent to the storage controller, and/or groups a set of responses from the storage controller for the requesting agent to process. Semantic guidance for data storage is provided and interaction with the storage controller is extended to support a hierarchical protocol that aggregates across multiple requests. With the augmented storage controller, additional information can be tracked, such as a set of memory regions and sets of data requests. The memory regions can be tracked, for example, based on logical addresses. An option for tracking the memory regions and/or the data requests include an implicit barrier after the region set or request set that implies that they must be completed before other region sets or request sets may begin. A variant of this option is to specify a class of region sets or request sets with a tag, such that serialization happens only for subsequent sets with a matching tag, whereas sets with different tags may be overlapped or reordered. The augmented data controller can also be used to insert one or more barriers in the middle of a sequence of requests that enables synchronization to happen within data storage rather than taking a round trip all the way back to the requesting agent. Through the additional features, the augmented data controller can increase throughput and minimize maximal tail latency through improved management of data requests and responses.

FIG. 1 illustrates a block diagram of an example of a data storage system 100 having a storage processing interface constructed according to the principles of the disclosure. Data storage system 100 includes data storage 110, a storage processing interface 120, a requesting agent 130 and/or a networking element 140. The data storage system 100 can also include additional components represented by requesting agent 132 and computing device 150. The data storage 110 includes a data medium 114 and a storage controller 116.

Data storage 110 is configured to retain digital data in a computer-readable medium, which is represented by data medium 114 in FIG. 1. The data medium 114 can be non-volatile memory, such as flash memory, magnetic disks, such as hard disc drives (HDDs), or another computer readable medium. The flash memory can be, for example, a NAND memory. The data medium 114 can also be a solid-state storage device, such as an SSD, or a DNA data storage device. The data medium 114 includes one or more sensing buffers (not shown) that are used to temporarily store data in response to a data request before the data is sent to the requestor, such as requesting agent 130. The sensing buffers can process a whole page of data from the data medium 114 and, if more than one sensing buffer is present, processing by each of the sensing buffers can be done concurrently.

Storage controller 116 is configured to manage communications with the data medium 114, such as communications with the requesting agent 130, using one or more channels or busses. The storage controller 116 can also be configured to provide additional functions for the data medium 114, such as encryption, compression, and error correction. The logic of the storage controller 116 can be implemented as hardware, software, or a combination thereof. The storage controller 116 can be, for example, an application-specific integrated circuit (ASIC) having an embedded processor. Other components or devices may be configured to perform one or more of the functions of the storage controller 116. As such, some of the functionality of the storage controller 116 can be offloaded to another computing device. For example, a computing device coupled to the communication bus 122 may be programmed to perform one or more functions of the storage controller 116. The device can be, for example, a CPU or a GPU that is more efficient at performing the hardware implemented functions of the storage controller 116. Instead of just data storage 110, the computing device can be configured to provide control functions for multiple data storage devices. Computing device 150 is shown as an example.

Storage processing interface 120 is configured to communicatively connect and process communications with the data storage 110 to and from the requesting agent 130 and the networking element 140. The storage processing interface 120 includes a communication bus 122 and an augmented data controller 126. The communication bus 122 is configured to physically connect the data storage 110, the requesting agent 130, and the networking element 140 for communication therebetween. Multiple requesting agents can be coupled to the data storage 110 via the communication bus 122. One or more of the multiple requesting agents can be coupled to the communication bus 122 via a networking element, such as networking element 140. FIG. 1 provides an example of a requesting agent 132, in addition to requesting agent 130, which is coupled to the data storage 110 via the networking element 140 and the communication bus 122. Requesting agent 130 will be used as an example for other requesting agents, including requesting agent 132. The communication bus 122 can be a high-speed interconnect. For example, the communication bus 122 can be a peripheral component interconnect (PCI) bus, a PCI express (PCIe) bus, a compute express link (CXL), an NVLink, or a network. Examples of communications via the communication bus 122 include data requests from the requesting agent 130 to the data storage 110 and data responses from the data storage 110 to the requesting agent 130.

The requesting agent 130 can be a processor, such as a GPU or a CPU. The networking element 140 can be a networking device, such as a network interface card (NIC) or a microprocessor designed for networking. For example, the networking element 140 can be a data processing unit (DPU). The networking element 140 can be configured to map a region of the data medium 114 for access by the networking element 140. For example, the networking element 140 can use User Memory Registration (UMR). The UMR can use one or more of a repeat count, a fixed chunk size, and/or a fixed stride. The UMR can also parse and operate on a list of non-strided items.

The augmented data controller 126 of the storage processing interface 120 is configured to provide augmented instructions to storage controller 116 for performing operations associated with obtaining data from the data storage 110 for one or more requesting agents, such as requesting agent 130 or networking element 140. As shown in FIG. 1, the augmented data controller 126 can be located within data storage 110. As noted above, the logic of the augmented data controller 126 can also be integrated in another device such as the requesting agent 130, the networking element 140, or within another data storage device besides the data storage 110. The augmented data controller 126 can be integrated in the storage controller 116. The logic can also be distributed over multiple devices, such as those just mentioned. The logic of the augmented data controller 126 corresponds to one or more algorithms that are directed to the operations of the augmented instructions provided to the storage controller 116 for obtaining the data from the data storage 110.

The augmented instructions generated by the augmented data controller 126 coordinate the data requests to the storage controller 116 and data responses from the storage controller 116. The data requests can be from the requesting agent 130 and the data response sent to requesting agent 130. As noted above, the requesting agent 130 will be used herein in various examples to represent other requesting agents, such as requesting agent 132. For example, requests may also be from the networking element 140, such as from a requesting agent 132 connected to the networking element 140. The augmented instructions can include an aggregated data request from multiple individual data requests from one or more requesting agents. As such, the augmented data controller 126 can be configured to aggregate multiple individual data requests from requesting agent 130, requesting agent 132, or from both, into a single aggregated data request. A number of the data requests in the aggregated data request can be included with the request. The number of the data requests can be specified as a number or as a list of tagged requests with a unique ending. The aggregated data request can provide guidance to the storage controller 116 for greater efficiency and control of processing.

The augmented instructions can also include an aggregated response request that instructs the storage controller 116 to group multiple related responses into a single aggregated data response for delivery to the requesting agent 130. A format for a response may include a number of the data requests that were fulfilled and/or an indication why unfulfilled requests were not fulfilled. A response format, for example, may include a multi-bit encoding of the error describing why the full set of requested responses were not fulfilled. One or more of an aggregated data request or an aggregated data response can be based on semantic information from the requesting agent 130.

The augmented instructions can include directions for the storage controller 116 to track at least one set of memory regions of the data medium 114 based on logical addresses. The tracking can be specified based on a pair of metadata controls that request opening of the tracking and closing of the tracking. The request for opening can be deferrable based on the availability of tracking resources. The tracking resources can be a set of memory regions of the data medium 114 and each of the memory regions can include at least one of a starting address or a size. The tracking resources can also be a set of data requests and each of the requests can include at least one of a starting address or a size associated with memory regions of the data medium 114, or a command. The tracking resources can be, for example, implemented as an array of items with a number of items and a unique identifier.

The tracking can end according to different events. For example, tenure of the tracking can end with completion of all data requests of the set of data requests (members). Tenure of the tracking can also end with the detection of an error, detected by the augmented data controller 126. Errors may include a failure to data that passes data corruption checks, or that fails to be provided within an acceptable time limit.

Upon a failure, the same request may be retried, or data retrieval may be attempted from an alternate location. The alternate location may be provided by a data integrity service, such as an agent which manages data replication. Detection and handling of errors may happen on every thread, e.g. on the GPU, rather than in some other service, such as on the CPU.

Regarding the tracking, a number and granularity of the memory region set can be specified for a list of tagged memory regions. Unique encoding, for example, can be used as a tag for the tagged regions. The unique encoding can be of multiple bits and include one or more of an optional list of the tagged memory regions, the tag, or one or more policies associated with the tag.

The one or more policies can vary. Examples of different policies include policies directed to processing, such as, complete a set of read commands before mixing with write commands, avoid a refresh or garbage collection while open, buffer a set of writes before writing back to storage, replicate write-once data to multiple locations, and avoid pre-reading of data from the data medium 114 for a partial write. One or more policies can be for a single data request or can apply to a set of data requests. Regardless if for a single data request or a data request set, a message can be used to specify the one or more policies. A message can also specify the one or more policies associated with a tag, the tag, and/or a number of requests with the tag. The message can be or be part of the semantic information provided by the requesting agent 130. A tag can be used to identify the requests of a data request set.

The policies directed to a set of data requests can differ from those associated with a single request. For example, policies for a set of data request can specify to prevent processing of any requests of the data request set unless resources are available to promptly complete all requests in the data request set. The grouping of requests for common “all or nothing” handling can increase the efficiency of both the storage controller 116 and the requesting agent 130. For example, the requesting agent 130 can be a GPU and enabling warps to make a coordinated set of data requests can allow better forward progress. Promptly is a tightly-bounded amount of time that corresponds to one or more sources of delay being removed as a precondition.

The policies of a data request set can also include one or more of sharing a common notification of the requests, designating a single queue for the data medium resource for the data request set, maximally distributing requests of the data request set across different queues of a resource, communicating a relative priority of the data request set and communicating special handling of the data request set. The special handling can include managing checking of data quality based on probability of data corruption and managing the checking can include omitting the checking of the data quality based on probability of data corruption. A policy can indicate that the checking is to be performed using a higher level of software, such as a redundant array of independent disks (RAID) or other data integrity checking software.

A policy can indicate to perform a two-level error checking scheme. The two-level error checking scheme can include, for example, reading a portion of a whole page of data from data medium 114 into a buffer (not shown) of the data storage 110, reading a portion of the whole page of data, using check bits associated with the portion for checking the portion, releasing the portion of the whole page to the requesting agent 130 when no errors are detected on the portion, and checking the whole page of data on the buffer when an error is detected in the portion. In another example, the two-level error checking scheme can include reading a portion of a whole page of data from the data medium 114 into a buffer, reading a portion of the whole page of data, using check bits associated with the portion for checking the portion, releasing the portion of the whole page from the requestor buffer when no errors are detected on the portion, and checking the whole page of data on the buffer when an error is detected on the portion.

Additionally, the augmented data instructions may enable synchronization by, for example, inserting one or more barriers into a sequence of data request sets. The inserting may be performed, for example, by the requesting agent 130. The augmented data instructions can also specify using an implicit completion barrier after one data request set and/or after a data response set. The augmented data instructions can also use tags to specify a class of data request sets and/or a class of data response sets for ordering processing thereof. The ordering of the processing may specify serial processing of requests or responses having the same tag or specify overlapping or reordering of requests or responses with different tags.

FIG. 2 illustrates a block diagram of an example of an augmented data controller 200 constructed according to the principles of the disclosure. The augmented data controller 200 is configured to perform one or more operations associated with obtaining data from data storage for one or more requesting agents. The augmented data controller 200 provides an example of the augmented data controller 126 of FIG. 1.

The augmented data controller 200 receives one or more data requests from a requesting agent or agents that are directed to a storage controller of a data storage. Additionally, the augmented data controller 200 receives one or more data responses from the storage controller that are directed to the requesting agent(s) for the one or more data requests. In addition to data requests, the augmented data controller 200 is also configured to receive semantic information from the one or more requesting agents.

The augmented data controller 200 also includes one or more processors that are configured to perform one or more operations. The operations include, for example, providing augmented instructions to a storage controller associated with the data storage, wherein the augmented instructions coordinate data requests from the one or more requesting agents to the storage controller and data responses from the storage controller to the requesting agent(s). As such, the augmented data controller 200 is configured to generate augmented data instructions for the one or more data requests, the one or more data responses, or a combination of both.

FIG. 3 illustrates a block diagram of another example of an augmented data controller 300 constructed according to the principles of the disclosure. The augmented data controller 300 of FIG. 3 includes one or more communications interface, represented by communications interface 310, one or more memories, represented by memory 320, and one or more processors, represented by processor 330. The various components of the augmented data controller 300 can communicate via wireless or wired conventional connections. As noted above, a portion of the augmented data controller 300 can be located at one or more locations.

Communications interface 310 is configured to transmit and receive data. For example, communications interface 310 can receive requests, semantic information, and commands from one or more requesting agents. The semantic information is a word or multiple words that provide semantic guidance for processing one or more data requests and/or one or more data responses. The semantic information can be used to improve IOPs when accessing the data. The semantic information can include the commands and/or additional contextual information that may correspond to requests and/or represent policies for processing requests and/or responses. Examples of commands include put, get, flush, group, and signal after count of requests with a given tag. A group command might be a hint to optionally prioritize completion of a set of requests before starting another group. Or it could be semantic, e.g. signal only after a given group of requests is completed. The semantic information may also include tags, such as colored tags, that may be used to identify certain requests, and that could either be integrated into a given command, e.g. put with a green tag, or separately, e.g. the next 7 requests have a green tag. The tags can be used as indexes or with indexes into a table. Communications from the requesting agents can be received via a communications bus, such as communication bus 122 of FIG. 1. The communications interface 310 can also receive responses from and provide augmented instructions to a storage controller, such as storage controller 116 of FIG. 1.

Memory 320 can be configured to store a series of operating instructions that direct the operation of processor 330 when initiated, including supporting code representing one or more algorithms for processing data requests and responses using the augmented instructions. Memory 320 is a non-transitory computer-readable medium. Multiple types of memory can be used for the data storage systems and memory 320 can be distributed.

Processor 330 can be one or more processors. Processor 330 can be a combination of processor types, such as a CPU, a GPU, a single instruction multiple data (SIMD) processor, or other processor types. Processor 330 can be a virtual process supported by a processing unit. Processor 330 can be dedicated circuitry within a processor. Processor 330 can be a code process running on a processor. Processor 330 can be configured to, for example, generate augmented instructions.

Processor 330 can be an integrated circuit. In some aspects, processor 330, communications interface 310, memory 320, or various combinations thereof, can be an integrated circuit. Processor 330 includes the logic to communicate with communications interface 310 and memory 320, and perform the functions described herein, including generating augmented instructions based on the semantic information.

FIG. 4 illustrates a flow diagram of an example method 400 of obtaining data from data storage for one or more data requests carried out according to the principles of the disclosure. One or more of the steps of method 400 can be carried out by an augmented data controller and/or a storage processing interface, such as storage processing interface 120 and augmented data controllers 126, 200, and 300 as disclosed herein. One or more algorithms for processing data requests and responses using augmented instructions can be used for at least some of the steps of method 400. Method 400 begins at step 405.

In step 410, one or more data requests are received. The data request or requests can be from a single requesting agent or from multiple requesting agents and directed to one or more storage controller of one or more data storage, such as storage controller 116 of data storage 110. An augmented data controller can receive the one or more data requests from the one or more requesting agents.

In step 420, semantic information is received. The semantic information provides contextual information associated with the one or more data requests. The semantic information can also be received by the augmented data controller from the one or more requesting agents. The semantic information can be from one, multiple, or all of the requesting agents.

Augmented instructions for obtaining data for the one or more data requests is generated in step 430 based on the semantic information. The augmented instructions coordinate data requests from the one or more requesting agent to a storage controller and data responses from the storage controller to the one or more requesting agents. The augmented instructions can include directions for the storage controller to track at least one set of memory regions of the data storage based on logical addresses. The augmented instructions can also include directions for the storage controller to track at least one specific set of the data requests. Generating the augmented instructions can include generating commands and instructions for the storage controller based on the semantic information. The generating can also include providing the augmented instructions in the format or protocol used by the storage controller. The semantic information may be in a proper format when received. The augmented instructions can be generated by the augmented data controller.

In step 440 the data is obtained according to the augmented instructions. The data can be obtained from a data medium, such as data medium 114. The data could be obtained from a replicated source, such as computing device 150, according to the augmented instructions.

Method 400 continues to step 450 wherein the data is provided to the one or more requesting agents according to the augmented instructions. The data can be provided via a communication bus of a storage processing interface, such as communication bus 122 of storage processing interface 122. Method 400 then ends in step 460.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Various aspects of the disclosure can be claimed including the apparatuses, systems, and methods disclosed in the Summary. Each of those aspects can have one or more of the following additional elements in combination: Element 1: wherein the data requests are from multiple individual data requests of the one or more requesting agents and the augmented data controller is configured to aggregate the data requests into an aggregated data request. Element 2: wherein the aggregated data request is based on semantic information from the one or more requesting agents. Element 3: wherein the augmented data controller is configured to generate an aggregated response request that instructs the storage controller to group multiple related responses into a single aggregated data response for delivery to the one or more requesting agents. Element 4: wherein the aggregated data response is based on semantic information from the one or more requesting agent Element 5: wherein the tracking is specified based on a pair of metadata controls that request opening of the tracking and closing of the tracking. Element 6: wherein the request for opening is deferrable based on the availability of tracking resources. Element 7: wherein the tracking resources are a set of memory regions and each of the memory regions include at least one of a starting address or a size. Element 8: wherein the tracking resources are a set of requests and each of the requests include at least one of a starting address, a size, or a command. Element 9: wherein the tracking resources are implemented as an array of items with a number of items and a unique identifier. Element 10: wherein a number and granularity of the at least one memory region set is specified for a list of tagged regions. Element 11 wherein the at least one memory region set includes unique encoding that serves as a tag for the tagged regions. Element 12: wherein the encoding is of multiple bits and includes one or more of an optional list, the tag, or a policy. Element 13: wherein the augmented instructions specify one or more policies to apply to the at least one memory region set. Element 14: wherein a message specifies at least one of a tag, policies associated with the tag, or a number of requests with the tag. Element 15: wherein the message is part of semantic information provided by the one or more requesting agents. Element 16: wherein the one or more policies include completing a set of read commands before mixing with write commands. Element 17: wherein the one or more policies include avoiding a refresh or garbage collection while open. Element 18: wherein the one or more policies include buffering a set of writes before writing back to the storage. Element 19: wherein the one or more policies include replicating write-once data to multiple locations. Element 20: wherein the one or more policies include avoiding pre-reading of data from the data storage for a partial write. Element 21: wherein the communication bus is a PCIe bus. Element 22: wherein the tracking is specified based on a pair of metadata controls that request opening of the tracking and closing of the tracking. Element 23: wherein a number and granularity of the at least one memory region set is specified for a list of tagged regions. Element 24 wherein the augmented instructions specify one or more policies to apply to the at least one memory region set. Element 25: wherein at least a portion of the augmented data controller is located in the one or more requesting agents, the storage controller, the data storage, or a networking device coupled to the communication bus. Element 26: wherein the augmented data controller is located in the networking device that uses User Memory Registration (UMR). Element 27: wherein the UMR uses a repeat count, a fixed chunk size, or a fixed stride. Element 28: wherein the UMR parses and operates on a list of non-strided items. Element 29: wherein the augmented data controller is located in the storage controller. Element 30: wherein the one or more requesting agent is a graphic processing unit. Element 31: wherein the augmented instructions include an aggregated data request based on the data requests and the semantic information. Element 32: wherein the augmented instructions include an aggregated response request that instructs the storage controller to group multiple of the responses that are related into a single aggregated data response for delivery to the one or more requesting agents. Element 33: further comprising providing the data to the one or more requesting agents according to the augmented instructions. Element 34: wherein the data requests are from multiple individual data requests of the one or more requesting agents and the augmented data controller is configured to aggregate the data requests into an aggregated data request. Element 35: wherein the aggregated data request is based on semantic information from the one or more requesting agents. Element 36: wherein the augmented data controller is configured to generate an aggregated response request that instructs the storage controller to group multiple related ones of the data responses into a single aggregated data response for delivery to the one or more requesting agents. Element 37: wherein the aggregated response request is based on semantic information from the one or more requesting agents. Element 38: wherein tenure of the tracking ends with completion of all data requests of the at least one set of the data requests. Element 39: wherein tenure of the tracking ends with detection of an error. Element 40: wherein a response format for the data responses includes a number of the data requests of the at least one set of the data requests that were fulfilled. Element 41: wherein the response format further includes a multi-bit encoding of an error describing why a full set of the at least one set of the data requests were not fulfilled. Element 42: wherein a number of the data requests of the at least one set of the data requests is specified. Element 43: wherein the number of the data requests is specified as a number or as a list of tagged requests with a unique ending. Element 44: wherein one or more policies to apply to the at least one set of the data requests are specified. Element 45: wherein a message specifies the one or more policies. Element 46: wherein the message is part of semantic information provided by the one or more requesting agents. Element 47: wherein the one or more policies to apply include preventing processing any data requests of the at least one set of the data requests unless resources are available to promptly complete all data requests in the at least one set of the data requests. Element 48: wherein promptly is a tightly-bounded amount of time that corresponds to one or more sources of delay being removed as a precondition. Element 49: wherein the one or more policies to apply include sharing a common notification of the data requests of the at least one set of data requests. Element 50: wherein the one or more policies to apply include designating a single queue of a resource for the at least one set of the data requests. Element 51: wherein the data requests of the at least one set of the data requests are identified by a tag. Element 52: wherein the one or more policies to apply include maximally distributing the data requests of the at least one set of the data requests across different queues of a resource. Element 53: wherein the one or more policies to apply include communicating a relative priority of the at least one set of the data requests. Element 54: wherein the one or more policies to apply include communicating special handling of the at least one set of data requests. Element 55: wherein the special handling includes managing checking of data quality based on probability of data corruption. Element 56: wherein managing the checking includes omitting the checking of the data quality based on probability of data corruption. Element 57: wherein the one or more policies to apply include performing checking using a higher level of software. Element 58: wherein the one or more policies to apply include performing a two-level error checking scheme. Element 59: wherein the two-level error checking scheme includes reading a portion of a whole page of data from a data medium of the data storage into a buffer, reading the portion of the whole page of data, using check bits associated with the portion for checking the portion, releasing the portion of the whole page to the one or more requesting agents when no errors are detected on the portion, and checking the whole page of data on the buffer when an error is detected on the portion. Element 60: wherein the two-level error checking scheme includes reading a portion of a whole page of data from a data medium of the data storage into a buffer, reading the portion of the whole page of data, using check bits associated with the portion for checking the portion, releasing the portion of the whole page from the buffer when no errors are detected on the portion, and checking the whole page of data on the buffer when an error is detected on the portion. Element 61: wherein the communication bus is a PCIe bus. Element 62: wherein tenure of the tracking ends with completion of all data requests of the at least one set of the data requests or with detection of an error. Element 63: wherein a response format for the data responses includes a number of the data requests of the at least one set of the data requests that were fulfilled, a multi-bit encoding of an error describing why a full set of the at least one set of the data requests were not fulfilled, or a combination of both. Element 64: wherein a number of the data requests of the at least one set of the data requests is specified via semantic information received from the one or more requesting agents. Element 65: wherein one or more policies to apply to the at least one set of the data requests are specified via semantic information received from the one or more requesting agents. Element 66: wherein at least a portion of the augmented data controller is located in the one or more requesting agents, the storage controller, the data storage, or a networking device coupled to the communication bus. Element 67: wherein the augmented instructions include an aggregated data request based on the data requests and the semantic information. Element 68: wherein the augmented instructions include an aggregated response request that instructs the storage controller to group multiple of the data responses that are related into a single aggregated data response for delivery to the one or more requesting agents. Element 69: further comprising providing the data to the one or more requesting agents according to the augmented instructions. Element 70: wherein the augmented data controller is configured to form at least one data request set from the data requests and at least one data response set from the data responses. Element 71: wherein the augmented instructions enable using implicit completion barriers after the at least one data request set, after the at least one data response set, or after both the at least one data request set and the at least one data response set. Element 72: wherein the augmented instructions enable using tags to specify a class of the data request set for ordering processing thereof, to specify a class of the data response set for ordering processing thereof, or to specify both a class of the data request sets and a class of the data response sets ordering the processing. Element 73: wherein the ordering of the processing includes serial processing of requests having the same tag or serial processing of responses having the same tag. Element 74: wherein the ordering of the processing includes overlapping or reordering of requests with different tags or responses with different tags. Element 75: wherein the augmented instructions further enable synchronization of the data request set. Element 76: wherein the synchronization is enabled by inserting one or more barriers into a sequence of the data request set. Element 77: wherein the inserting is performed by the one or more requesting agents. Element 78: wherein the communication bus is a peripheral component interconnect (PCI), a NVLink, or a network. Element 79: wherein the augmented data controller is configured to form data request sets from the data requests and data response sets from the data responses. Element 80: wherein the augmented instructions enable using implicit completion barriers after the data request sets and after the data response sets. Element 81: wherein the augmented instructions enable using tags to specify classes of the data request sets and classes of the data response sets for ordering processing thereof. Element 82: wherein the ordering of the processing includes serial processing of requests having the same tag and responses having the same tag. Element 83: wherein the ordering of the processing includes overlapping or reordering of requests with different tags or responses with different tags. Element 84: wherein the augmented instructions enable synchronization of the data request sets by inserting one or more barriers into a sequence of the data request sets. Element 85: wherein the inserting is performed by the one or more requesting agents. Element 86: wherein at least a portion of the augmented data controller is located in at least one of the one or more requesting agents, the storage controller, or the data storage. Element 87: wherein the data storage includes a data medium configured to store the data, wherein the data medium is a flash memory. Element 88: further comprising a computing device coupled to the storage processing interface and configured to provide back-up storage for at least some of the data of the data medium. Element 89: further comprising a computing device coupled to the storage processing interface and configured to perform one of more functions of the storage controller.

What is claimed is:

1. An augmented data controller configured to perform one or more operations associated with obtaining data from data storage for one or more requesting agents, the operations comprising:
providing augmented instructions to a storage controller associated with the data storage, wherein the augmented instructions coordinate data requests from the one or more requesting agents to the storage controller and data responses from the storage controller to the one or more requesting agents and include directions for the storage controller to track at least one set of the data requests.

2. The augmented data controller as recited in claim 1, wherein the data requests are from multiple individual data requests of the one or more requesting agents and the augmented data controller is configured to aggregate the data requests into an aggregated data request.

3. The augmented data controller as recited in claim 2, wherein the aggregated data request is based on semantic information from the one or more requesting agents.

4. The augmented data controller as recited in claim 1, wherein the augmented data controller is configured to generate an aggregated response request that instructs the storage controller to group multiple related ones of the data responses into a single aggregated data response for delivery to the one or more requesting agents.

5. The augmented data controller as recited in claim 4, wherein the aggregated response request is based on semantic information from the one or more requesting agents.

6. The augmented data controller as recited in claim 1, wherein tenure of the tracking ends with completion of all data requests of the at least one set of the data requests.

7. The augmented data controller as recited in claim 1, wherein tenure of the tracking ends with detection of an error.

8. The augmented data controller as recited in claim 1, wherein a response format for the data responses includes a number of the data requests of the at least one set of the data requests that were fulfilled.

9. The augmented data controller as recited in claim 8, wherein the response format further includes a multi-bit encoding of an error describing why a full set of the at least one set of the data requests were not fulfilled.

10. The augmented data controller as recited in claim 1, wherein a number of the data requests of the at least one set of the data requests is specified.

11. The augmented data controller as recited in claim 10, wherein the number of the data requests is specified as a number or as a list of tagged requests with a unique ending.

12. The augmented data controller as recited in claim 1, wherein one or more policies to apply to the at least one set of the data requests are specified.

13. The augmented data controller as recited in claim 12, wherein a message specifies the one or more policies.

14. The augmented data controller as recited in claim 13, wherein the message is part of semantic information provided by the one or more requesting agents.

15. The augmented data controller as recited in claim 12, wherein the one or more policies to apply include preventing processing any data requests of the at least one set of the data requests unless resources are available to promptly complete all data requests in the at least one set of the data requests.

16. The augmented data controller as recited in claim 15, wherein promptly is a tightly-bounded amount of time that corresponds to one or more sources of delay being removed as a precondition.

17. The augmented data controller as recited in claim 12, wherein the one or more policies to apply include sharing a common notification of the data requests of the at least one set of data requests.

18. The augmented data controller as recited in claim 12, wherein the one or more policies to apply include designating a single queue of a resource for the at least one set of the data requests.

19. The augmented data controller as recited in claim 18, wherein the data requests of the at least one set of the data requests are identified by a tag.

20. The augmented data controller as recited in claim 12, wherein the one or more policies to apply include maximally distributing the data requests of the at least one set of the data requests across different queues of a resource.

21. The augmented data controller as recited in claim 12, wherein the one or more policies to apply include communicating a relative priority of the at least one set of the data requests.

22. The augmented data controller as recited in claim 12, wherein the one or more policies to apply include communicating special handling of the at least one set of data requests.

23. The augmented data controller as recited in claim 22, wherein the special handling includes managing checking of data quality based on probability of data corruption.

24. The augmented data controller as recited in claim 23, wherein managing the checking includes omitting the checking of the data quality based on probability of data corruption.

25. The augmented data controller as recited in claim 19, wherein the one or more policies to apply include performing checking using a higher level of software.

26. The augmented data controller as recited in claim 19, wherein the one or more policies to apply include performing a two-level error checking scheme.

27. The augmented data controller as recited in claim 26, wherein the two-level error checking scheme includes reading a portion of a whole page of data from a data medium of the data storage into a buffer, reading the portion of the whole page of data, using check bits associated with the portion for checking the portion, releasing the portion of the whole page to the one or more requesting agents when no errors are detected on the portion, and checking the whole page of data on the buffer when an error is detected on the portion.

28. The augmented data controller as recited in claim 26, wherein the two-level error checking scheme includes reading a portion of a whole page of data from a data medium of the data storage into a buffer, reading the portion of the whole page of data, using check bits associated with the portion for checking the portion, releasing the portion of the whole page from the buffer when no errors are detected on the portion, and checking the whole page of data on the buffer when an error is detected on the portion.

29. A storage processing interface, comprising:
a communication bus; and
an augmented data controller connected to the communication bus and configured to perform one or more operations associated with obtaining data from data storage for one or more requesting agents coupled to the communication bus, the operations including:
providing augmented instructions to a storage controller associated with the data storage, wherein the augmented instructions coordinate data requests from the one or more requesting agents to the storage controller and data responses from the storage controller to the one or more requesting agents, and include directions for the storage controller to track at least one set of the data requests.

30. The storage processing interface as recited in claim 29, wherein the communication bus is a PCIe bus.

31. The storage processing interface as recited in claim 29, wherein tenure of the tracking ends with completion of all data requests of the at least one set of the data requests or with detection of an error.

32. The storage processing interface as recited in claim 29, wherein a response format for the data responses includes a number of the data requests of the at least one set of the data requests that were fulfilled, a multi-bit encoding of an error describing why a full set of the at least one set of the data requests were not fulfilled, or a combination of both.

33. The storage processing interface as recited in claim 29, wherein a number of the data requests of the at least one set of the data requests is specified via semantic information received from the one or more requesting agents.

34. The storage processing interface as recited in claim 29, wherein one or more policies to apply to the at least one set of the data requests are specified via semantic information received from the one or more requesting agents.

35. The storage processing interface as recited in claim 29, wherein at least a portion of the augmented data controller is located in the one or more requesting agents, the storage controller, the data storage, or a networking device coupled to the communication bus.

36. The storage processing interface as recited in claim 29, wherein the augmented data controller is located in a networking device that uses User Memory Registration (UMR).

37. The storage processing interface as recited in claim 29, wherein the augmented data controller is located in the storage controller.

38. The storage processing interface as recited in claim 29, wherein the one or more requesting agents is a graphic processing unit.

39. A method of obtaining data from data storage for one or more data requests from one or more requesting agents, the method comprising:
receiving one or more data requests and semantic information associated with the one or more data requests, wherein at least a portion of the semantic information is generated by and is received from the one or more requesting agents;
generating augmented instructions based on the semantic information, wherein the augmented instructions coordinate data requests from the one or more requesting agents to a storage controller and data responses from the storage controller to the one or more requesting agents, wherein the storage controller is associated with the data storage and the augmented instructions include directions for the storage controller to track at least one set of the data requests; and
obtaining data for the data requests from the data storage according to the augmented instructions.

40. The method as recited in claim 39, wherein the augmented instructions include an aggregated data request based on the data requests and the semantic information.

41. The method as recited in claim 39, wherein the augmented instructions include an aggregated response request that instructs the storage controller to group multiple of the data responses that are related into a single aggregated data response for delivery to the one or more requesting agents.

42. The method as recited in claim 39, further comprising providing the data to the one or more requesting agents according to the augmented instructions.
